(19) United States
(12) Patent Application Publication
(10) Pub. No.: US 2014/0017527 A1
(43) Pub. Date: Jan. 16, 2014

(54) NONAQUEOUS ELECTROLYTE SECONDARY BATTERY

(71) Applicant: Denis Yau Wai YU, Hong Kong (CN)

(72) Inventor: Denis Yau Wai YU, Hong Kong (CN)

(73) Assignee: SANYO ELECTRIC CO., LTD., Moriguchi-shi, Osaka (JP)

(21) Appl. No.: 14/006,896

(22) PCT Filed: Apr. 10, 2012
(86) PCT No.: PCT/JP2012/059749

§ 371 Date: Sep. 23, 2013

(30) Foreign Application Priority Data
Apr. 27, 2011 (JP) 2011-099288

(51) Int. Cl. H01M 10/42

(52) U.S. Cl. CPC H01M 10/4235
USPC 429/61

(57) ABSTRACT

An object of the invention is to improve the safety of nonaqueous electrolyte secondary batteries in the event of overcharging. The invention is directed to a nonaqueous electrolyte secondary battery including a positive electrode containing a positive electrode active material, a negative electrode, a nonaqueous electrolyte, a separator and a current interrupting element, the positive electrode active material including a first compound represented by the general formula LiCoₓM₁₋ₓO₂ (wherein 0.1≦x≦1 and M is one or more metal elements including at least Ni or Mn) and a second compound generating a gas when the positive electrode potential becomes not less than 4.5 V versus lithium metal, the current interrupting element being a pressure-sensitive current interrupting element.

### TECHNICAL FIELD

The present invention relates to nonaqueous electrolyte secondary batteries.

### BACKGROUND ART

The recent increase in the capacity of nonaqueous electrolyte secondary batteries has led to a need for further improvement in the safety of nonaqueous electrolyte secondary batteries.

An approach to improving the safety of nonaqueous electrolyte secondary batteries is the use of a pressure-sensitive current interrupting element that is operated by the generation of gas from the decomposition of an electrolytic solution during overcharging to block the current. In Patent Literature 1, an overcharge protection additive which generates a large amount of gas during overcharging is added to an electrolytic solution to promote the current interruption.

### CITATION LIST

### Patent Literature

PTL 1: Japanese Published Unexamined Patent Application No. 9-50822

### SUMMARY OF INVENTION

### Technical Problem

An object of the invention is to improve the safety of nonaqueous electrolyte secondary batteries in the event of overcharging.

### Solution to Problem

The present invention is directed to a nonaqueous electrolyte secondary battery including a positive electrode containing a positive electrode active material, a negative electrode, a nonaqueous electrolyte, a separator and a current interrupting element, the positive electrode, active material including a first compound represented by the general formula LiCoₓM₁₋ₓO₂ (wherein 0.1≦x≦1 and M is one or more metal elements including at least Ni or Mn) and a second compound generating a gas when the positive electrode potential becomes not less than 4.5 V versus lithium metal, the current interrupting element being a pressure-sensitive current interrupting element.

The addition of an overcharge protection additive to an electrolytic solution can result in a decrease in storage properties due to the reaction of the additive with the negative electrode or the decomposition of the additive at a high temperature. On the other hand, the present invention ensures safety in the event of overcharging without such a problem.

It is particularly preferable that the metals M in the above general formula include Ni and Mn because such a positive electrode active material has a small change in crystal structure when the positive electrode potential reaches 4.4 V or above versus lithium metal. Further, x preferably satisfies 0.2≦x≦0.95, and more preferably satisfies 0.3≦x≦0.7.

Examples of the second compounds used in the positive electrode active material in the invention include Li₂MnO₃, LiₓFeO₄, Li₆MnO₅, Li₆CoO₆, Li₂CO₃, LiC₂O₄ and Li₂CuO₂. In particular, Li₂MnO₃, is preferable because this compound easily generates a gas when the positive electrode potential reaches 4.6 V versus lithium metal.

For example, the nonaqueous electrolyte used in the invention may be any nonaqueous electrolyte utilized in conventional nonaqueous electrolyte secondary batteries. Examples thereof include cyclic carbonate esters, chain carbonate esters and ethers. Examples of the cyclic carbonate esters include ethylene carbonate and propylene carbonate. Examples of the chain carbonate esters include dimethyl carbonate, ethyl methyl carbonate and diethyl carbonate. Examples of the ethers include 1,2-dimethoxyethane.

The nonaqueous electrolyte used in the invention contains a lithium salt utilized in conventional nonaqueous electrolyte secondary batteries. Examples thereof include LiPF₆ and LiBF₄.

For example, the negative electrode active material used in the invention may be any negative electrode active material utilized in conventional nonaqueous electrolyte secondary batteries. Examples thereof include graphites, lithium, silicon and silicon alloys.

For example, the pressure-sensitive current interrupting element used in the invention may be any pressure-sensitive current interrupting element utilized in conventional nonaqueous electrolyte secondary batteries. Examples thereof include pressure-sensitive current interrupting elements operating at 1.4±0.3 MPa.

Where necessary, the nonaqueous electrolyte secondary batteries of the invention may include other battery components, for example, any battery components utilized in conventional nonaqueous electrolyte secondary batteries.

### Advantageous Effects of Invention

According to the present invention, the second compound generates a gas when the positive electrode potential reaches 4.5 V or above versus lithium metal, and the pressure-sensitive current interrupting element detects the consequent increase in the pressure in the battery and interrupts the current. As a result, the overcharging of the battery can be suppressed.

### BRIEF DESCRIPTION OF DRAWINGS

FIG. 1 is a schematic view of a laminate cell used in EXAMPLES of the invention.

FIG. 2 is a schematic view of a cylindrical secondary battery used in EXAMPLES of the invention.

### DESCRIPTION OF EMBODIMENTS

Hereinbelow, the present invention will be described in further detail based on EXAMPLES. However, the scope of the invention is not limited by such EXAMPLES. The present invention may be modified appropriately within the scope of the invention.

### EXAMPLES

### [Fabrication of Positive Electrodes]

### Example 1

Lithium hydroxide (LiOH) was added to an aqueous solution containing Ni, Co and Mn to prepare NiCoMn hydroxide. The obtained NiCoMn hydroxide was mixed together with lithium carbonate in accordance with the stoichiometric ratio LiNi_{0.25}Co_{0.50}Mn_{0.25}O₂. Thereafter, the mixture was calcined in air at 900°C. for 24 hours to (live a first compound. The first compound was analyzed by powder X-ray diffractometry and was found to have a layered structure classified into the space group R3-m.

Manganese carbonate (MnCO₃) and lithium hydroxide were mixed with each other in accordance with the stoichiometric ratio Li₂MnO₃. Thereafter, the mixture was calcined in air at 400′C. for 48 hours to give a second compound.

The first compound and the second compound were mixed with each other in a mass ratio of 98:2 to give a positive electrode active material. The positive electrode active material was mixed with acetylene black and polyvinylidene fluoride in a mass ratio of 90:5:5. N-methyl-2-pyrrolidone (NMP) was added to the resultant mixture, thereby preparing a positive electrode mixture slurry. The positive electrode mixture slurry was applied to an aluminum foil as a collector and was dried in air at 80° C. to form an electrode. The electrode was rolled and was cut to a 32 mm×44 mm size. A positive electrode a1 was thus fabricated.

### Example 2

A positive electrode a2 was fabricated in the same manner as in EXAMPLE 1, except that the positive electrode active material was prepared by mixing the first compound and the second compound with each other in a mass ratio of 96:4.

### Example 3

A positive electrode a3 was fabricated in the same manner as in EXAMPLE 1, except that the positive electrode active material was prepared by mixing the first compound and the second compound with each other in a mass ratio of 94:5.

### Example 4

A positive electrode a4 was fabricated in the same manner as in EXAMPLE 1, except that the positive electrode active material was prepared by mixing the first compound and the second compound with each other in a mass ratio of 92:8.

### Comparative Example 1

A positive electrode b1 was fabricated in the same manner as in EXAMPLE 1, except that the first compound alone was used as the positive electrode active material.

### COMPARATIVE EXAMPLE 2

A positive electrode b2 was fabricated in the same manner as in EXAMPLE 1, except that the positive electrode active material was prepared by mixing the first compound and the second compound with each other in a mass ratio of 90:10.

### [Fabrication of Laminate Cells]

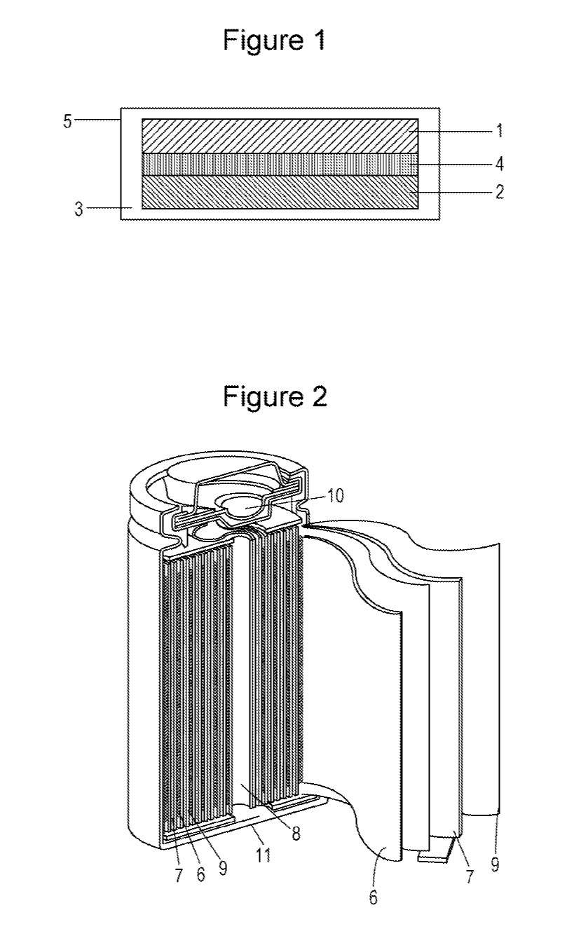

Laminate cells illustrated in FIG. 1 were fabricated using a positive electrode 1, negative electrode 2, a nonaqueous electrolytic solution 3, a separator 4 and a casing 5. The positive electrode 1 was any of the positive electrodes a1 to a4, b1 and b2. The negative electrode 2 was lithium metal. The nonaqueous electrolytic solution 3 was a 3:7 by volume mixture of ethylene carbonate and diethyl carbonate and contained 1 mol/L of LiPF₆. The separator 4 was a polyethylene separator. The casino 5 was a 55 mm×55 mm aluminum-laminated casing.

### [Charge Discharge Cycle Test 1]

The laminate cell was charged at a constant current of 20 mA/g until the voltage reached 4.3 V, and was thereafter charged at a constant voltage of 4.3 V until the current value reached 2 mA/g. Thereafter, the well was discharged at a constant current of 20 mA/g until the voltage reached 2.5 V, and a discharge capacity was obtained as the discharge capacity in the first cycle. Another cycle of charging and discharging was performed under similar conditions.

### [Overcharge Test 1]

The laminate cell subjected to the charge discharge cycle test 1 was charged at a constant current of 20 mA/g until the voltage reached 4.8 V, and was thereafter charged at a constant voltage of 4.8 V until the current value reached 2 mA/g.

### [Measurement of Gas Generation Amount]

The change Δt in the thickness of the laminate cell after the overcharge test 1 was measured, and the volume ΔV of the generated as was determined using Equation 1. The change Δt is a value obtained by subtracting the thickness of the laminate cell after the first cycle of the charge discharge cycle test 1 from the thickness of the laminate cell after the overcharge test 1.

ΔV(m³)=0.055(m)×0.055(m)×Δt (m) (Equation 1)

The obtained ΔV was substituted in Equation 2 to determine the gas generation amount Δn (mol/g) per mass of the positive electrode active material.

Δn=PΔV/RTM (Equation 2)

Here, P indicates the pressure, P=1×10⁵ (Pa); R the gas constant, R=8.314 (JK⁻mol⁻¹); T the temperature, T=298 (K); and M the mass (g) of the positive electrode active material. The obtained Δn values are described in Table 1.

TABLE 1

| | | | | | | Cylindrical |
|---|---|---|---|---|---|---|
| | | | | | | secondary |
| | | | | | | batteries |
| | | Mass M of | | | | Pressure- |
| | Amount of | positive | Laminate cells | | | sensitive |
| | second | electrode | Discharge | | Gas generation | current |
| Positive | compound | active material | capacity in first | Thickness | amount Δn | interrupting |
| electrodes | (mass %) | (g) | cycle (mAh/g) | change Δt (m) | (mol/g) | element |
| a1 | 2 | 0.303 | 154.0 | +4.9 × 10⁵ | 1.97 × 10⁻⁵ | Operated |
| a2 | 4 | 0.311 | 150.7 | +1.21 × 10⁻⁴ | 4.76 × 10⁻⁵ | Operated |
| a3 | 6 | 0.281 | 148.8 | +1.90 × 10⁻⁴ | 8.27 × 10⁻⁵ | Operated |
| a4 | 8 | 0.293 | 145.5 | +3.13 × 10⁻⁴ | 1.28 × 10⁻⁴ | Operated |
| b1 | 0 | 0.309 | 156.0 | +4 × 10⁻⁶ | 1.19 × 10⁻⁶ | Not operated |
| b2 | 10 | 0.301 | 143.1 | — | — | — |

[Fabrication of Cylindrical Secondary Batteries having Pressure-Sensitive Current Interrupting Elements]

Cylindrical secondary batteries illustrated in FIG. 2 were fabricated using a positive electrode 6, a negative electrode 7, a nonaqueous electrolytic solution 8, a separator 9, a pressure-sensitive current interrupting element 10 and a casing 11. The positive electrode 6 was one fabricated in the same manner as any of the positive electrodes a1 to a4 and b1. The negative electrode 7 was graphite. The nonaqueous electrolytic solution 8 was a 3:7 by volume mixture of ethylene carbonate and diethyl carbonate and contained 1 mol/L of LiPF₆. The separator 9 was a polyethylene separator. The pressure-sensitive current interrupting element 10 was one operating at 1.4±0.3 MPa. The casing 11 was a stainless steel cylindrical casing 14 mm in diameter and 430 mm in height.

Because the laminate cell having the positive electrode b2 exhibited a relatively slightly lower discharge capacity in the first cycle, cylindrical secondary batteries with the positive electrode b2 were not fabricated.

### [Charge Discharge Cycle Test 2]

The cylindrical secondary battery was charged at a constant current of 20 mA/g until the voltage reached 4.2 V, and was thereafter charged at a constant voltage of 4.2 until the current value reached 2 mA/g. Thereafter, the battery was discharged at a constant current of 20 mA/g until the voltage reached 2.4 V, and a discharge capacity was obtained as the discharge capacity in the first cycle. Another cycle of charging and discharging was performed under similar conditions. When the voltage of the cylindrical secondary battery is 4.2 V, the positive electrode potential is approximately 4.3 V versus lithium metal. When the voltage of the cylindrical secondary battery is 2.4 V, the positive electrode potential is approximately 2.5 V versus lithium metal.

### [Overcharge Test 2]

The cylindrical secondary battery subjected to the charge discharge cycle test 2 was charged at a constant current of 20 mA/g until the voltage reached 4.7 V, and was thereafter charged at a constant voltage of 4.7 V until the current value reached 2 mA/g. When the voltage of the cylindrical secondary battery is 4.7 V, the positive electrode potential is approximately 4.8 V versus lithium metal.

Whether the pressure-sensitive current interrupting elements of the cylindrical secondary batteries Were operated during the overcharge test 2 was examined. The results are described in Table 1.

In the cylindrical secondary batteries which contained the positive electrodes a1 to a4 having a gas generation amount of not less than 1.90×10⁻⁵ mol/g, as shown in Table 1, the pressure-sensitive current interrupting elements were operated during the overcharge test 2 and the current was interrupted. On the other hand, the electrode b1 had a gas generation amount of less than 1.90×10⁻⁵ mol/g, and the pressure-sensitive current. interrupting element in the cylindrical secondary battery containing this electrode was not operated during the overcharge test 2 and failed to interrupt the current.

In the cylindrical secondary batteries in which the pressure-sensitive current interrupting elements were operated, charging can be discontinued by the operation of the pressure-sensitive current interrupting elements even in the event that, for example, a charge controller does not function and fails to stop. charging. In contrast, the cylindrical secondary batteries in which the pressure-sensitive current interrupting elements were not operated have a risk of malfunction due to continuous charging without the operation of the pressure-sensitive current interrupting elements.

Further, as shown in Table 1, the laminate cell which contained the positive electrode b2 with a mass proportion of the second compound in excess of 8 mass % relative to the total mass of the positive electrode active material exhibited a slightly lower discharge capacity in the first cycle compared to the laminate cells which contained the positive electrodes a1 to a4 with a mass proportion of the second compound of from 1 to 8 mass % relative to the total mass of the positive electrode active material. Based on this result, it has been demonstrated that the mass proportion of the second compound is more preferably from 1 to 8 mass % relative to the total mass of the positive electrode active material.

Overcharging does not usually occur because the voltage of batteries is controlled by electronic devices including the batteries or by rechargers. The present invention prevents malfunction of batteries in the event that electronic devices or rechargers fail to control charging, and thereby further enhances the safety of conventional nonaqueous electrolyte secondary batteries.

### REFERENCE SIGNS LIST

1 . . . POSITIVE ELECTRODE OF LAMINATE CELL

2 . . . NEGATIVE ELECTRODE OF LAMINATE CELL

3 . . . NONAQUEOUS ELECTROLYTIC SOLUTION OF LAMINATE CELL

4 . . . SEPARATOR OF LAMINATE CELL

5 . . . CASING OF LAMINATE CELL

6 . . . POSITIVE ELECTRODE OF CYLINDRICAL SECONDARY BATTERY

7 . . . NEGATIVE ELECTRODE OF CYLINDRICAL SECONDARY BATTERY

8 . . . NONAQUEOUS ELECTROLYTIC SOLUTION OF CYLINDRICAL SECONDARY BATTERY

9 . . . SEPARATOR OF CYLINDRICAL SECONDARY BATTERY

10 . . . PRESSURE-SENSITIVE CURRENT INTERRUPTING ELEMENT OF CYLINDRICAL SECONDARY BATTERY

11 . . . CASING OF CYLINDRICAL SECONDARY BATTERY

1. A nonaqueous electrolyte secondary battery comprising a positive electrode containing a positive electrode active material, a negative electrode, a nonaqueous electrolyte, a separator and a current interrupting element,
the positive electrode active material including a first compound represented by the general formula LiCoxM1-xO2 (wherein 0.1≦x≦1 and M is one or more metal elements including at least Ni or Mn) and a second compound generating a gas when the positive electrode potential becomes not less than 4.5 V versus lithium metal,
the current interrupting element being a pressure-sensitive current interrupting element.

2. The nonaqueous electrolyte secondary battery according to claim 1, wherein when the positive electrode potential is not less than 4.5 V versus lithium metal, the amount of the gas generated per mass of the positive electrode active material is not less than 1.9×10-5 mol/g.

3. The nonaqueous electrolyte secondary battery according'to claim 1, wherein the first compound has a crystal structure including a layered structure.

4. The nonaqueous electrolyte secondary battery according to claim 1, wherein the second compound is represented by the general formula Li2MnO3.

5. The nonaqueous electrolyte secondary battery according to claim 1, wherein the mass proportion of the second compound is 1 to 8 mass % relative to the total mass of the positive electrode active material.

6. The nonaqueous electrolyte secondary battery according to claim 1, which is charged and discharged such that the positive electrode potential becomes less than 4.5 V versus lithium metal.

7. The nonaqueous electrolyte secondary battery according to claim 2, wherein the first compound has a crystal structure including a layered structure.
